(19) United States
(12) Patent Application Publication
(10) Pub. No.: US 2015/0006935 A1
(43) Pub. Date: Jan. 1, 2015

(54) METHOD FOR CONTROLLING CACHE MEMORY AND APPARATUS FOR THE SAME

(71) Applicant: Electronics and Telecommunications Research Institute, Daejeon (KR)

(72) Inventors: Jin Ho HAN, Seoul (KR); Young Su KWON, Daejeon (KR); Kyoung Seon SHIN, Daejeon (KR); Kyung Jin BYUN, Daejeon (KR); Nak Woong EUM, Daejeon (KR)

(21) Appl. No.: 14/300,942

(22) Filed: Jun. 10, 2014

(30) Foreign Application Priority Data
Jun. 26, 2013 (KR) 10-2013-0074061

(51) Int. Cl. G06F 1/32

(52) U.S. Cl. CPC G06F 1/3275
USPC 713/323

(57) ABSTRACT

Disclosed are a processor capable of reducing power consumption of a cache by controlling power mode of the cache and a method for the same. A processor may comprise a processor core; a cache storing instructions to be executed in the processor core; and a cache management part controlling the cache based on a processor operation mode indicating a state of the processor core determined according to algorithm executed in the processor core. Thus, power consumption of cache may be reduced, and degradation of processor core performance may be prevented by controlling power mode of cache considering an operation mode of the processor.

### CLAIM FOR PRIORITY

This application claims priorities to Korean Patent Application No. 10-2013-0074061 filed on Jun. 26, 2013 in the Korean Intellectual Property Office (KIPO), the entire contents of which are hereby incorporated by references.

### BACKGROUND

1. Technical Field

Example embodiments of the present invention relate to a technique of controlling cache memory and more specifically to a method for controlling cache memory through power control based on operational states of a processor, and an apparatus for the same.

2. Related Art

Since performances of mobile devices are becoming higher according to advances of information communication technologies and spreads of ubiquitous environments, it is demanded that embedded processors should have high performance. Also, since a performance gap between processor and memory is increased, more cache memory is needed to support high performance processor.

Tasks to be performed by a processor may be defined as combinations of multiple instructions. That is, instructions are stored in a memory device, and the instructions are inputted to a processor sequentially. Accordingly, the processor performs operations indicated by each of the instructions sequentially at every clock cycle.

Basically, a processor may comprise at least one processor core, a translation lookaside buffer (TLB), and a cache.

The TLB may act a function of translating virtual address into physical address for driving application based on operating system, and the cache may act a role of increasing instruction read/write speed of the processor core by temporarily storing instructions or data stored in an external memory within a processor chip.

It takes much time (about 10 to 100 clock cycles) for a processor core to read instructions or data from an external memory, and which is a reason making the processor core stay in an idle state in which the processor core does not process any tasks for a long time.

The cache is a unit storing instructions to be used by the processor core, and is implemented as a memory device embedded in a processor chip and connected directly to the processor core. The reason why the cache is used is that the cache can handle small amount of data (for example, several megabytes) very fast as opposed that the external memory can handle large amount of data (for example, up to several hundreds of gigabytes) slowly. In other words, the cache may act a role of temporary storage for the external memory having large capacity.

Thus, cache may make significant effect on performance of processor. A processor core is configured to send address of desired instructions to a cache, and the cache retrieves the instructions stored in it using the address and transmits the retrieved instructions to the processor core. At this time, if a specific instruction is not available in a cache when a processor core demands the specific instruction, the specific instruction should be read from an external memory, and so the processor core should maintain idle state while the specific instruction is being read from an external memory.

If a processor operates at low frequency, a cache does not need large capacity and can read instruction code from an external memory every time the cache receives instruction request from the processor core.

However, if a processor operates at high frequency, a high performance of a cache is demanded so that a cache should have large capacity and a function of decreasing the number of communications with an external memory. Also, a cache used in a processor operating at variable frequency should have an optimized structure according to a performance of a processor. The optimized structure of cache may reduce power consumption of processor and prevent degradation of processor performance.

### SUMMARY

Accordingly, example embodiments of the present invention are provided to substantially obviate one or more problems due to limitations and disadvantages of the to related art.

Example embodiments of the present invention provide a processor capable of reducing power consumption of a cache by controlling power mode of the cache.

Example embodiments of the present invention also provide a method for reducing power consumption of a cache by controlling power mode of the cache.

In some example embodiments, a processor may comprise a processor core; a cache storing instructions to be executed in the processor core; and a cache management part controlling the cache based on a processor operation mode indicating state of the processor core determined according to algorithm executed in the processor core.

Here, the cache management part may control power allocated to the cache according to the processor operation mode.

Here, the cache management part may determine a number of sets and a number of ways based on the processor operation mode.

Here, the cache may comprises a set association control module selecting at least one set based on the number of sets; and a way control module selecting at least one way memory based on the number of ways. Also, the cache management part may provide power to the at least one way memory included in the at least one set selected by the set association module.

In other example embodiments, a method for controlling cache memory may comprise determining a processor operation mode indicating state of a processor core according to algorithm executed in the processor core; and controlling a cache interworking with the processor core according to the processor operation mode.

Here, in the controlling a cache, power allocated to the cache may be controlled according to the processor operation mode.

Here, in the controlling a cache, a number of sets and a number of ways may be determined based on the processor operation mode, and transferred to the cache so as to control the cache.

Also, in the controlling a cache, at least one set may be selected using the number of sets, and at least one way memory may be selected based on the number of ways, and power may be provided to the at least one way memory included in the selected at least one set.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to explain a processor performing a method for controlling cache according to an example embodiment of the present invention;

FIG. 2 is a block diagram to explain a configuration of a cache according to an example embodiment of the present invention;

FIG. 3 is a block diagram to explain a method for controlling cache according to an example embodiment of the present invention; and

FIG. 4 is a flow chart to explain a method for controlling cache memory according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

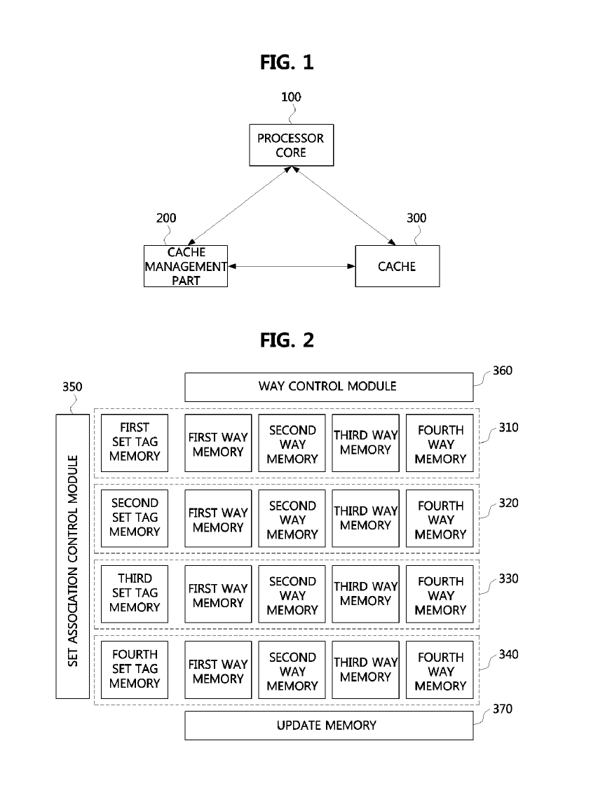

FIG. 1 is a conceptual diagram to explain a processor performing a method for controlling cache according to an example embodiment of the present invention.

First, a processor may mean a device capable of performing specific functions directed by program codes by reading instructions stored in an external storage device, analyzing the instructions read from the external storage device, performing specific operations on operands indicated by the analyzed instructions, and storing results of the specific operation in the external storage device.

Referring to FIG. 1, a processor according to an example embodiment of the present invention may comprise at least one processor core 100, a cache management part 200, and a cache 300. In the processor, the cache 300 may be controlled efficiently through information exchanges between the processor core 100, the cache management part 200, and the cache 300.

According to an example embodiment of the present invention, the cache management part 200 controls power mode of the cache 300 according to state of the processor core 100 so that power consumption of the cache 300 can be reduced while a performance of the processor core is maintained.

The cache 300 may store instructions to be executed in the processor core 100. Generally, the cache 300 may be implemented as a structure of static RAM (SRAM), and the power consumed in the cache 300 may be classified into a static energy which is consumed basically for maintaining stored data, and a dynamic energy which is consumed when accesses on the cache occur. For example, in order to read data from the cache 300, it is necessary to pre-charge corresponding tag array and data array to make the cache 300 changed into a state in which the data in it can be read out immediately.

The processor core 100 may perform operations based on implemented algorithms. Especially, the processor core 100 may identify performance of the processor core 100 needed for executing an algorithm before the processor core 100 executes the corresponding algorithm. That is, the processor core 100 may determine a processor operation mode indicating state of the processor core 100 which is determined according to an algorithm to be executed. Also, the processor core 100 may transfer information about the processor operation mode to the cache management part 200.

The cache management part 200 may control the cache 300 based on the processor operation mode indicating a state of the processor core 100 determined according to an algorithm to be executed by the processor core 100. That is, the cache management part 200 may identify the processor operation mode, and control a power mode of the cache 300 based on the identified processor operation mode.

The cache management part 200 may determine ‘Number of Sets’ and ‘Number of Ways’ according to the processor operation mode.

Here, ‘Number of Sets’ may mean the number of sets to be activated, each of which comprises a plurality of way memories and a tag memory. As the smaller number of sets are determined to be used, the smaller capacity of the cache 300 may be used. Also, ‘Number of Ways’ may mean the number of way memories to be activated in the set(s) selected by the ‘Number of Sets’.

The cache 300 may select at least one set based on the ‘Number of Sets’ and select at least one way memory in the selected set(s) based on the ‘Number of Ways’.

Accordingly, the cache management part 200 may provide power to at least one way memory based on the number of ways which is included in a set indicated by the set number.

For example, the cache 300 which is controlled by the cache management part 200 according to the present invention may have a structure of ‘N-way set associate structure’. The N-way set associate structure may mean a cache structure which can store the instructions and the addresses of instructions up to maximum N in a specific set respectively. In other words, the cache 300 having ‘N-way set associate structure’ may transmit the instruction which has the address of instruction requested to the processor core 100, by receiving and analyzing the address of instruction requested by the processor core 100, and by reading the N instructions and the N addresses of instructions stored in the corresponding set. However, the cache 300 according to an example embodiment of the present invention is not limited to a cache having N-way set associate structure.

Therefore, by adjusting the set number and the number of ways which can be stored in the cache 300 having N-way set associated structure, a capacity of the cache 300 required for storing data can be decreased, and power consumption of the cache 300 may be reduced.

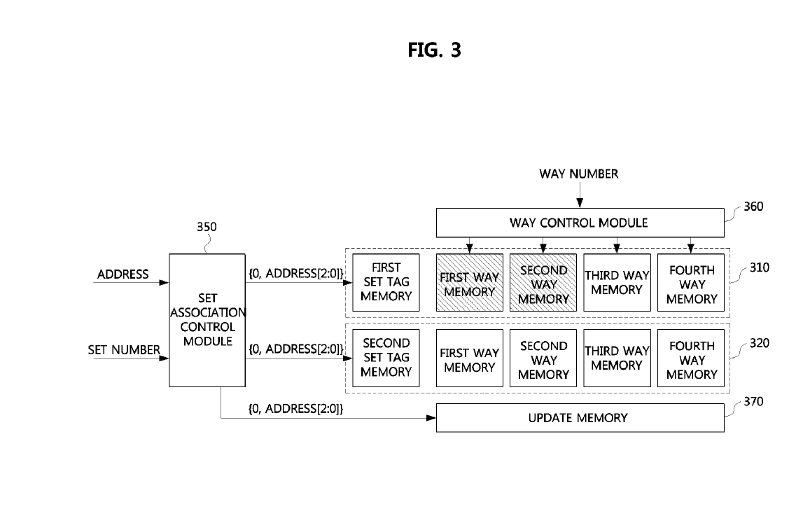

FIG. 2 is a block diagram to explain a configuration of a cache according to an example embodiment of the present invention, and FIG. 3 is a block diagram to explain a method for controlling cache according to an example embodiment of the present invention.

Referring to FIG. 2, a cache according to an example embodiment of the present invention may comprise a plurality of sets 310 to 340 each of which includes a tag memory and a plurality of way memories, and an update memory 370. Also, the cache may comprise a set association control module 350 and a way control module 360.

The tag memory may store addresses for instructions, and the way memories may store instructions. Also, the update memory 370 may store information about whether instructions are changed by the processor core 100.

Here, the tag memories and the way memories are grouped into at least one set 310, 320, 330, and 340. For example, one tag memory and four way memories may constitute one set. Here, a set associated with the first tag memory may be referred to as a first set 310, and a set associated with the second tag memory may be referred to as a second set 320, and a set associated with the third tag memory may be referred to as a third set 330, and a set associated with the fourth tag memory may be referred to as a fourth set 340. Each of the sets may include four way memories.

That is, referring to FIG. 2, the cache 300 may comprise four sets 310, 320, 330, and 340. However, the present invention does not limit the number of sets and configurations of the sets constituting the cache 300.

The set association control module 350 may receive the number of sets determined in the cache management part 200, and select at least one set based on the received number of sets.

Also, the way control module 360 may receive the number of ways determined in the cache management part 200, and select at least one way memories based on the number of ways.

Referring to FIG. 3, a procedure of selecting a set and way memories is explained in further detail. The cache 300 may comprise a first set 310 associated with a first tag memory and a second set 320 associated with a second memory. Also, each of the sets 310 and 320 may comprise four way memories.

For example, the set association control module 350 may receive the number of sets from the cache management part 200 and address of instruction to be read from the processor core 100, and generate an addressing signal for tag memories of the sets 310 and 320 based on the number of sets and the address received from the processor core 100. For example, the addressing signal may be generated by using some bits of the address received from the processor core 100 based on the number of sets received from the cache management part 200. As an example shown in FIG. 3, the addressing signal may be configured by using three least significant bits (for example, address[2:0]) of the received address and one most significant bit which is turned on or off according to the number of sets.

In an example illustrated in FIG. 3, when the first set 310 is desired to be selected, the set association module 350 may generate an addressing signal {0, address[2:0]} according to the number of sets (for example, 1) received from the cache management part. In another embodiment, when the first set 310 and the second set 320 are desired to be selected, the set association module 350 may generate an addressing signal {1, address[2:0]} according to the number of sets (for example, 2) received from the cache management part.

Also, the way control module 360 may receive the number of ways from the cache management part 200, and select at least one way memories among the four way memories based on the received number of ways. For example, a first way memory and a second way memory included in the first set 310 may be selected.

As a result, the cache 300 can use only the first tag memory, the first way memory, and the second way memory among the memories included in the first set 310. That is, the cache management part 200 may provide power to a specific tag memory and at least one way memory included in the set selected by the set association control module 350 and the way control module 360.

As explained above, the number of sets and the number of ways may be determined based on a processor operation mode indicating state of the processor core 100, and power consumption of the cache 300 may be reduced by activating only a tag memory and way memories included in the selected set based on the determined number of sets and the determined number of ways.

Also, since power mode of the cache 300 is controlled in consideration of the processor operation mode, degradation of performance of the processor core 100 may be prevented.

For convenience of explanation, each of components constituting a processor which can control power mode of cache based on a processor operation mode according to the present invention is explained respectively. However, at least two components among the explained components may be combined into a single component performing functions identical to those of the at least two components. Or, a component among the explained components may be divided to a plurality of sub-components. The scope of the present invention includes embodiments in which the explained components are integrated or the explained components are divided into a plurality of sub-components.

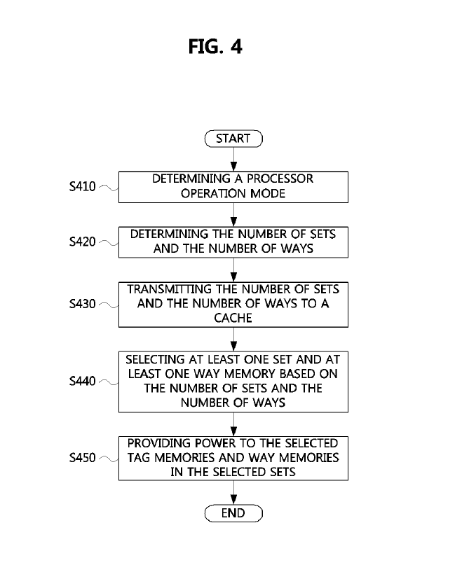

FIG. 4 is a flow chart to explain a method for controlling cache memory according to an example embodiment of the present invention.

Referring to FIG. 4, a method for controlling cache memory according to the present invention may comprise determining a processor operation mode indicating state of a to processor core 100 according to algorithm executed in the processor core, and controlling a cache 300 interworking with the processor core according to the processor operation mode.

A method for controlling cache memory according to the present invention may be applied to a cache 300 having ‘N-way set associate structure’. Here, the N-way set associate structure may mean a cache structure which can store the instructions and the addresses of instructions up to maximum N in a specific set respectively. However, application of the method according to the present invention is not limited to a cache having ‘N-way set associate structure’.

First, a processor operation mode may be determined by the processor core 100 at S410. Here, the processor operation mode may mean information about state of the processor core 100 determined according to algorithm to be executed by the processor core 100 based on a performance of the processor core 100.

A ‘Number of Sets’ and ‘Number of ways’ may be determined based on the processor operation mode at S420. Here, ‘Number of Sets’ may mean the number of sets to be activated, each of which comprises a plurality of way memories and a tag memory. As the smaller number of sets are determined to be used, the smaller capacity of the cache 300 may be used. Also, ‘Number of Ways’ may mean the number of way memories to be activated in the set(s) selected by the ‘Number of Sets’.

The number of sets and the number of ways may be transmitted to the cache 300 at S430. That is, the cache 300 may select at least one tag memory and at least one way memory to be activated using the number of sets and the number of ways at S440. That is, specific sets are selected using the number of sets, and way memories are selected based on the number of ways.

Resultantly, the selected at least one tag memory and the selected at least one way memory may be provided with power and activated. In other words, by adjusting the number of sets and the number of ways which can store data in the cache 300 having N-way set associated structure, a capacity of the cache 300 to be maintained for storing data can be decreased, and power consumption of the cache 300 may be reduced.

In addition, information about way memories included in a set which is provided with power may be transferred to the processor core 100.

Meanwhile, a method for controlling cache memory according to the present invention may be performed in a processor comprising the cache management part 200 which was described above. Also, the method may prevent degradation of processor core performance by controlling power mode of the cache 300 in consideration of an operation mode of the processor.

As explained above, a method for controlling cache memory and an apparatus for the same according to the present invention may reduce power consumption of cache by activation only a tag memory and way memories included in a set selected based on a processor operation mode indicating a state of processor core.

Also, degradation of processor core performance may be prevented by controlling power mode of cache considering an operation mode of the processor.

While the example embodiments of the present invention and their advantages have been described in detail, it should be understood that various changes, substitutions and alterations may be made herein without departing from the scope of the invention.

What is claimed is:

1. A processor comprising:
a processor core;
a cache storing instructions to be executed in the processor core; and
a cache management part controlling the cache based on a processor operation mode indicating state of the processor core determined according to algorithm executed in the processor core.

2. The processor of the claim 1, wherein the cache management part controls power allocated to the cache according to the processor operation mode.

3. The processor of the claim 1, wherein the cache management part determines a number of sets and a number of ways based on the processor operation mode.

4. The processor of the claim 3, wherein the cache comprises:
a set association control module selecting at least one set based on the number of sets; and
a way control module selecting at least one way memory based on the number of ways.

5. The processor of the claim 4, wherein the cache management part provides power to the at least one way memory included in the at least one set selected by the set association module.

6. A method for controlling cache memory, the method comprising:
determining a processor operation mode indicating state of a processor core according to algorithm executed in the processor core; and
controlling a cache interworking with the processor core according to the processor operation mode.

7. The method of claim 6, wherein in the controlling a cache, power allocated to the cache is controlled according to the processor operation mode.

8. The method of claim 6, wherein in the controlling a cache, a number of sets and a number of ways are determined based on the processor operation mode, and transferred to the cache so as to control the cache.

9. The method of claim 8, wherein in the controlling a cache, at least one set is selected using the number of sets, and at least one way memory is selected based on the number of ways, and power is provided to the at least one way memory included in the selected at least one set.
